(19) United States
(12) Patent Application Publication
(10) Pub. No.: US 2013/0237198 A1
(43) Pub. Date: Sep. 12, 2013

(54) SYSTEM AND METHOD FOR MANAGING DATA CALLS

(71) Applicants: Prashant Vashi, Cupertino, CA (US); Vikram B. Yerrabommanahalli, Cupertino, CA (US); Karthik Anantharaman, Cupertino, CA (US); Madhusudan Chaudhary, Cupertino, CA (US)

(72) Inventors: Prashant Vashi, Cupertino, CA (US); Vikram B. Yerrabommanahalli, Cupertino, CA (US); Karthik Anantharaman, Cupertino, CA (US); Madhusudan Chaudhary, Cupertino, CA (US)

(73) Assignee: Apple Inc., Cupertino, CA (US)

(21) Appl. No.: 13/413,587

(22) Filed: Mar. 6, 2012

(51) Int. Cl. H04W 4/00

(52) U.S. Cl. 455/418

(57) ABSTRACT

A wireless device described herein may be configured to wait for a period of time before originating a data call after receiving a data call termination request from another device. The period of time may be selected to ensure that a page request, such as for a voice call, is received by the wireless device before attempting to originate the data call.

### TECHNICAL FIELD

This disclosure relates to data communications, and more particularly, to systems and methods for delaying data call attempts in order to process an incoming voice call.

### DESCRIPTION OF THE RELATED TECHNOLOGY

Mobile wireless communication devices, such as a cellular telephone or a wireless personal digital assistant, can provide a wide variety of communication services including, for example, voice communication, text messaging, internet browsing, and electronic mail. These mobile wireless communication devices may communicate within a wireless communication network. These different services may be achieved by communicating traffic in different communication domains within the wireless communication network. For example, voice traffic may be carried in a first domain, such as a circuit switched domain. Data traffic may be carried in a second domain, such as a circuit switched domain or a packet switched domain. The communication of voice traffic by a mobile wireless communication device in the wireless communication network may be referred to as a “voice call.” The communication of data traffic by a mobile wireless communication device in the wireless communication network may be referred to as a “data call.”

Some wireless communication devices may only be capable of engaging in one of a voice call or a data call at a time, and unable to simultaneously engage in a voice call and a data call. Accordingly, systems and methods are needed for managing how the device handles the processing of voice calls and data calls that occur at approximately the same time.

### SUMMARY

The systems, methods and devices of the disclosure each have several innovative aspects, no single one of which is solely responsible for the desirable attributes disclosed herein.

One innovative aspect of the subject matter described in this disclosure can be implemented in a method of communicating in a wireless network. The method includes receiving, at a first unit, a data call termination request from a second unit. The method further includes waiting, by the first unit, for a time period before attempting to place a data call based on receipt of the data call termination request.

In an embodiment, the method further includes receiving, at the first unit, a page request for a voice call from the second unit during the time period, and accepting the voice call.

In another embodiment, the wireless network comprises a code division multiple access network and wherein the data call termination request comprises a release order.

In another embodiment, the time period is one or two time slots.

In another embodiment, the method further includes transitioning from a first state where a page request is not accepted to a second state where the page request is accepted based on receiving the data call termination request.

In another embodiment, the first state comprises at least one of the following: mobile station origination attempt substate, page response substate, and update overhead information sub state.

Another innovative aspect of the subject matter described in this disclosure can be implemented in a method of communicating in a wireless network. The method includes receiving, at a first unit, an indication of a pending voice call from a second unit. The method further includes transmitting, by the first unit, a data call termination request to a third unit based on the received indication.

In an embodiment, the data call termination request is configured to cause a recipient of the data call termination request to wait for a period of time before attempting to place a data call based on receipt of the data call termination request.

In another embodiment, the method further includes transmitting a page request for the pending voice call during the time period to the recipient.

Another innovative aspect of the subject matter described in this disclosure can be implemented in a wireless device. The wireless device includes a receiver configured to receive a data call termination request. The wireless device further includes a processor configured to wait for a time period before attempting to place a data call based on receipt of the data call termination request.

In one embodiment, the receiver is further configured to receive a page request for a voice call during the time period, and the processor is further configured to accept the voice call.

In another embodiment, the wireless network comprises a code division multiple access network and wherein the data call termination request comprises a release order.

In another embodiment, the processor is further configured to transition from a first state where a page request is not accepted to a second state where the page request is accepted based on receiving the data call termination request

Another innovative aspect of the subject matter described in this disclosure can be implemented in a wireless device. The wireless device includes a receiver configured to receive an indication of a pending voice call. The wireless device further includes a transmitter configured to transmit a data call termination request based on the received indication.

In one embodiment, the data call termination request is configured to cause a recipient of the data call termination request to wait for a period of time before attempting to place a data call based on receipt of the data call termination request.

In another embodiment, the transmitter is further configured to transmit a page request for the pending voice call during the time period to the recipient.

Another innovative aspect of the subject matter described in this disclosure can be implemented in an apparatus. The apparatus includes means for receiving a data call termination request. The apparatus further includes means for waiting for a time period before attempting to place a data call based on receipt of the call termination request.

Another innovative aspect of the subject matter described in this disclosure can be implemented in an apparatus. The apparatus includes means for receiving an indication of a pending voice call. The apparatus further includes means for transmitting a data call termination request based on the received indication.

Another innovative aspect of the subject matter described in this disclosure can be implemented in a non-transitory computer-readable medium. The medium includes code that, when executed by one or more processors, causes an apparatus to receive a data call termination request; and wait for a time period before attempting to place a data call based on receipt of the call termination request.

Another innovative aspect of the subject matter described in this disclosure can be implemented in a non-transitory computer-readable medium. The medium includes code that, when executed by one or more processors, causes an apparatus to receive an indication of a pending voice call; and transmit a data call termination request based on the received indication.

Details of one or more implementations of the subject matter described in this specification are set forth in the accompanying drawings and the description below. Other features, aspects, and advantages will become apparent from the description, the drawings, and the claims. Note that the relative dimensions of the following figures may not be drawn to scale.

### BRIEF DESCRIPTION OF THE DRAWINGS

FIG. 1 illustrates a wireless communication network 100.

FIG. 2 is a block diagram illustrating various components that may be utilized in a wireless device 202 that may be employed within the wireless communication system 100.

FIG. 3 is a state diagram illustrating establishment of a data call between devices in the wireless communication system of FIG. 1.

FIG. 4 is a state diagram illustrating an occurrence of a voice call being missed while establishing a data call between devices in the wireless communication system of FIG. 1.

FIG. 5 is a state diagram illustrating a procedure for ensuring receipt of a voice call while establishing a data call between devices in the wireless communication system of FIG. 1.

FIG. 6 is a flowchart 600 depicting an exemplary method for ensuring receipt of a voice call while establishing a data call between devices in the wireless communication system of FIG. 1.

### DETAILED DESCRIPTION

The following detailed description is directed to certain implementations for the purposes of describing the innovative aspects. However, the teachings herein can be applied in a multitude of different ways. The described implementations may be implemented in any devices that are configured to communicate in a wireless communications network, including devices configured to communicate in both voice calls and data calls. More particularly, it is contemplated that the implementations may be included in or associated with a variety of wireless communication devices such as, but not limited to, mobile telephones, multimedia Internet enabled cellular telephones, wireless devices, smartphones, Bluetooth® devices, personal data assistants (PDAs), hand-held or portable computers, netbooks, notebooks, smartbooks, tablets, and a variety of electronic devices. The teachings herein also can be used in other applications. Thus, the teachings are not intended to be limited to the implementations depicted solely in the Figures, but instead have wide applicability as will be readily apparent to a person having ordinary skill in the art.

The techniques described herein may be used for various wireless communication networks such as Code Division Multiple Access (CDMA) networks, Time Division Multiple Access (TDMA) networks, Frequency Division Multiple Access (FDMA) networks, Orthogonal FDMA (OFDMA) networks, Single-Carrier FDMA (SC-FDMA) networks, etc. The terms “networks” and “systems” are often used interchangeably. A CDMA network may implement a radio technology such as Universal Terrestrial Radio Access (UTRA), cdma2000, etc. UTRA includes Wideband-CDMA (W-CDMA) and Low Chip Rate (LCR). cdma2000 covers IS-2000, IS-95 and IS-856 standards. A TDMA network may implement a radio technology such as Global System for Mobile Communications (GSM). An OFDMA network may implement a radio technology such as Evolved UTRA (E-UTRA), IEEE 802.11, IEEE 802.16, IEEE 802.20, Flash-OFDM, etc. UTRA, E-UTRA, and GSM are part of Universal Mobile Telecommunication System (UMTS). Long Term Evolution (LTE) is an upcoming release of UMTS that uses E-UTRA. UTRA, E-UTRA, GSM, UMTS and LTE are described in documents from an organization named “3rd Generation Partnership Project” (3GPP). cdma2000 is described in documents from an organization named “3rd Generation Partnership Project 2” (3GPP2). These various radio technologies and standards, and others, are known in the art. The discussion herein will primarily focus on CDMA networks described in documents from 3GPP2. In particular, the discussion herein will primarily focus on 1× data calls and voice calls placed in CDMA networks as described in documents from 3GPP2. However, the same ideas may apply to other wireless access network technologies.

As discussed above, some wireless communication devices may only be capable of engaging in one of a voice call or a data call at a time, and may be unable to simultaneously engage in a voice call and a data call. Such a wireless communication device may originate a data call, such as a 1× data call. The wireless communication device may subsequently receive a page indicating that there is a voice call pending for the wireless device before the data call is established. It may be desirable for the voice call to take precedence over a data call since it is often the case that a voice call may be more time sensitive. Since the wireless communication device can communicate in only one of a voice call or a data call at a time, described herein are systems and methods for ensuring the voice call takes precedence and is established even when the wireless communication device is originating a data call.

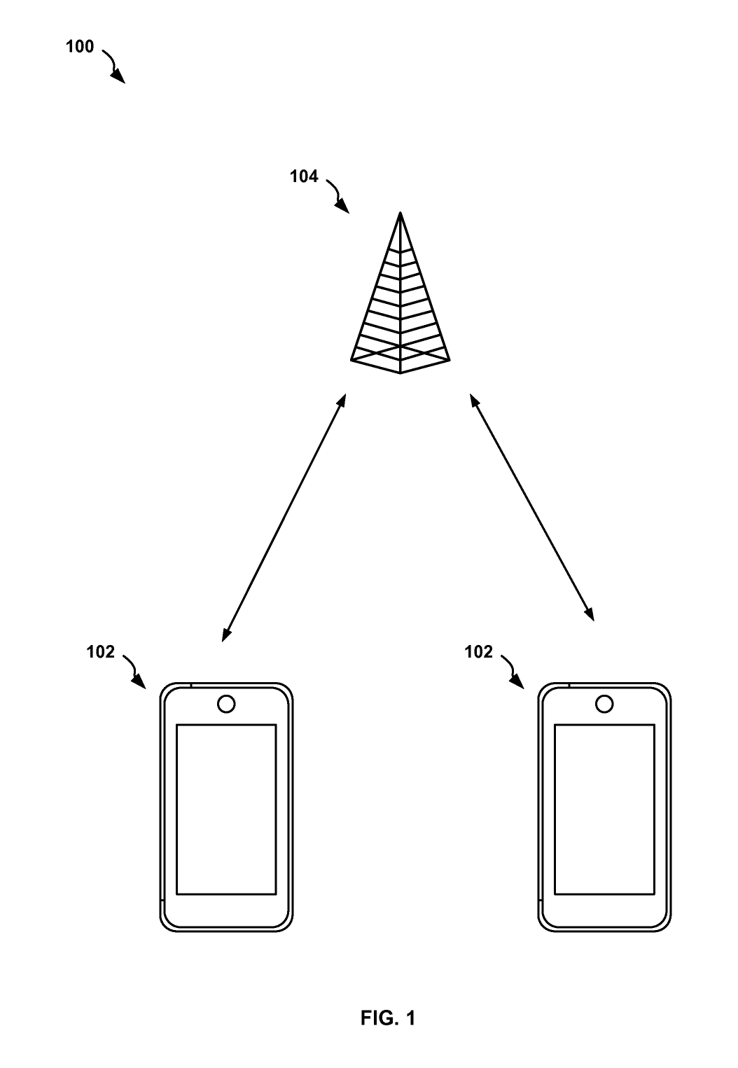

FIG. 1 illustrates a wireless communication network 100. The wireless communication network 100 may operate according to any of the suitable radio technologies described herein. The discussion herein, however, will focus on CDMA networks described in documents from 3GPP2. Accordingly, devices in the wireless communication network 100 may utilize a variety of processes and methods for transmissions between each other, including CDMA techniques.

The devices that communicate in the wireless communication network 100 may include one or more base stations (BS) 104, and one or more mobile stations (MS) 102.

A communication link that facilitates transmission from the BS 104 to one or more MSs 102 may be referred to as a downlink (DL), forward link, or a forward channel. A communication link that facilitates transmission from one or more MSs 102 to the BS 104 may be referred to as an uplink (UL), reverse link, or a reverse channel.

The BS 104 may provide wireless communication coverage to the MS 102 in a coverage area (e.g., a geographical area). A MS 102 may be associated with the BS 104 and use the BS 104 to facilitate wireless communication with other devices in the wireless communication network 100. For example, the MS 102 may transmit or receive traffic to or from the BS 104. The BS 104 may in turn relay the traffic to other devices in the wireless communication network 100. For example, the BS 104 may relay the traffic to a mobile switch center (MSC), not shown, that in turn relays the traffic from the BS 104 to other BSs, which in turn may relay the traffic to other MSs 102. As would be known by one of ordinary skill in the art, other devices may facilitate communication between MSs 102. Accordingly, MSs 102 may communicate with each other.

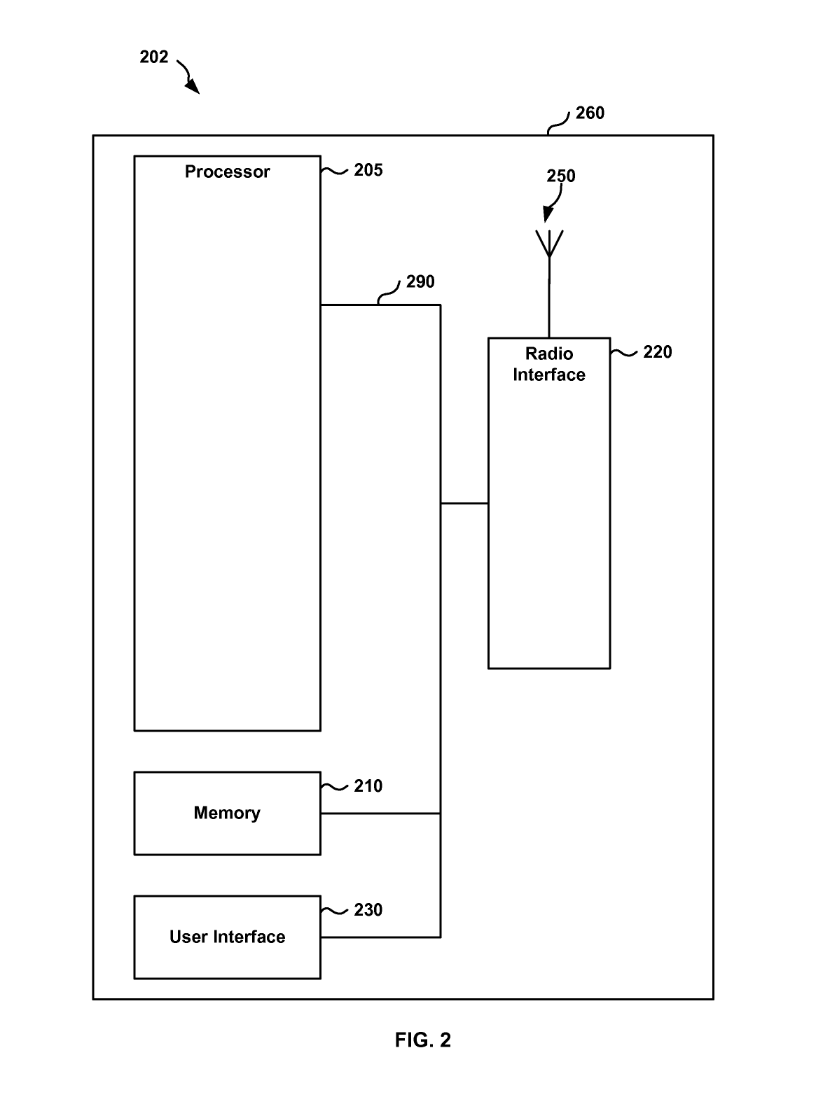

FIG. 2 is a block diagram illustrating various components that may be utilized in a wireless device 202 that itself may be employed within the wireless communication system 100. The wireless device 202 is an example of a device that may be configured to implement the various methods described herein. For example, the wireless device 202 may comprise the BS 104 or the MS 102. In the illustrated embodiment, the wireless device 202 includes a processor 205, a memory 210, a radio interface 220, a user interface 230, an antenna 250, and a housing 260. The wireless device 202 may be employed within the wireless communication system 100, described above with respect to FIG. 1.

The processor can serve to control operation of the wireless device 202. The processor 205 may also be referred to as a central processing unit (CPU). The memory 210 serves to provide instructions and data to the processor 205. The memory 210 can include read-only memory (ROM) and/or random access memory (RAM). A portion of the memory 210 can also include non-volatile random access memory (NVRAM). The processor 205 can perform logical and arithmetic operations based on program instructions stored within the memory 210. The instructions in the memory 210 can be executable to implement the methods described herein.

In various embodiments, the processor 205 can comprise or be a component of a processing system implemented with one or more processors. The one or more processors can be implemented with any combination of general-purpose microprocessors, microcontrollers, digital signal processors (DSPs), field programmable gate array (FPGAs), programmable logic devices (PLDs), controllers, state machines, gated logic, discrete hardware components, dedicated hardware finite state machines, or any other suitable entities that may perform calculations or other manipulations of information.

The processing system may also include machine-readable media for storing software. Software shall be construed broadly to mean any type of instructions, whether referred to as software, firmware, middleware, microcode, hardware description language, or otherwise. Instructions may include code (e.g., in source code format, binary code format, executable code format, or any other suitable format of code). The instructions, when executed by the one or more processors, cause the processing system to perform the various functions described herein.

The radio interface 220 can include one or more WiFi radios, one or more Bluetooth® radios, one or more cellular radios (for example, a CDMA radio), etc. In various embodiments, the radio interface 220 can transmit and receive data via the antenna 250 to other devices capable of wireless communication.

The user interface 230 can include, for example, a display, a proximity detector, one or more input buttons, a microphone, a speaker, and/or an interface port (for example, a Universal Serial Bus (USB) port, a High-Definition Multimedia Interface (HDMI) port, etc.). The display can include a touchscreen. The user interface 230 can include any element or component that conveys information to a user of the wireless device 220 and/or receives input from the user.

In the illustrated embodiment, various components of the wireless device 202 are coupled together by a bus system 290. The bus system 290 can include a data bus, for example, as well as a power bus, a control signal bus, and a status signal bus in addition to the data bus. Those of skill in the art will appreciate the components of the wireless device 202 may be coupled together or accept or provide inputs to each other using some other mechanism.

Although a number of separate components are illustrated in FIG. 2, those of skill in the art will recognize that one or more of the components may be combined or commonly implemented. Further, each of the components illustrated in FIG. 2 may be implemented using a plurality of separate elements.

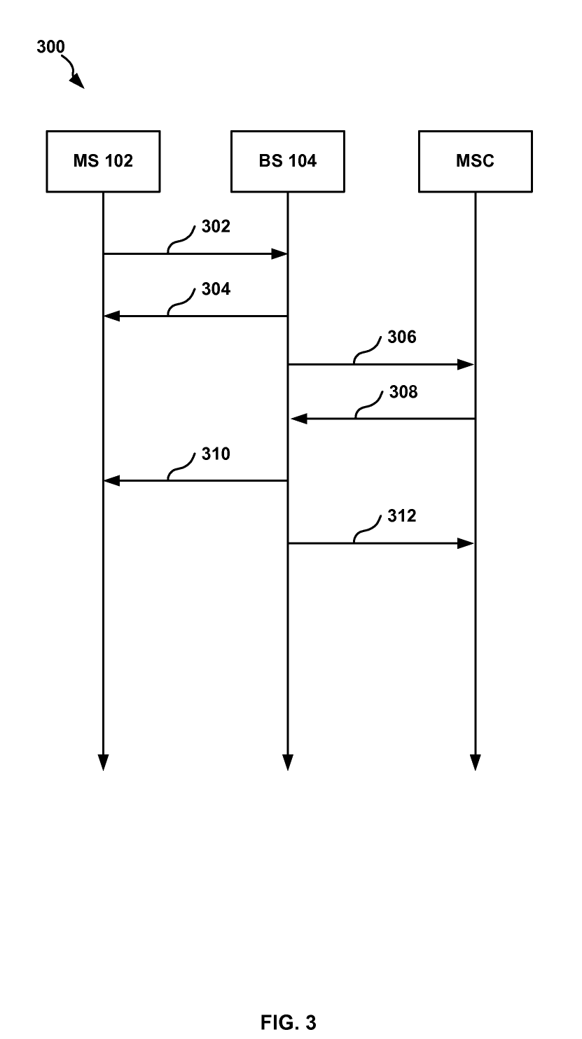

FIG. 3 is a state diagram 300 illustrating establishment of a data call between devices in the wireless communication system of FIG. 1. As shown, communication between devices is illustrated horizontally with arrows indicating the direction of communication. Further, the communications are shown in time, beginning at the top of FIG. 1 and continuing downward.

In one example of system operation, the MS 102 may have data to send to another device. Accordingly, the MS 102 may originate a data call (e.g., a 1× data call) by sending a data call origination request (e.g., a service option message) to the BS 104 as shown at 302. In response to the data call origination request, the BS 104 may transmit an acknowledgment (ACK) to the MS 102 indicating receipt of the data call origination request as shown at 304. Continuing, the BS 104 may send a request message (e.g., a service request) to the MSC to request the MS 102 to setup the data call as shown at 306. The MSC may respond with an assignment request message to the BS 104 to request a communication channel be assigned by the BS 104 to the MS 102 for communication between the BS 104 and the MS 102 as shown at 308. The BS 104 may send a channel assignment message to the MS 102 to initiate establishment of a radio traffic channel with the MS 102 as shown at 310. Once channel assignment is completed, the BS 104 may send an assignment complete message to the MSC as shown at 312. The MS 102 may then communicate in the data call. As would be understood by one of ordinary skill in the art, other devices and/or signals may be involved in establishing a data call in embodiments or examples other than those described with respect to FIG. 3.

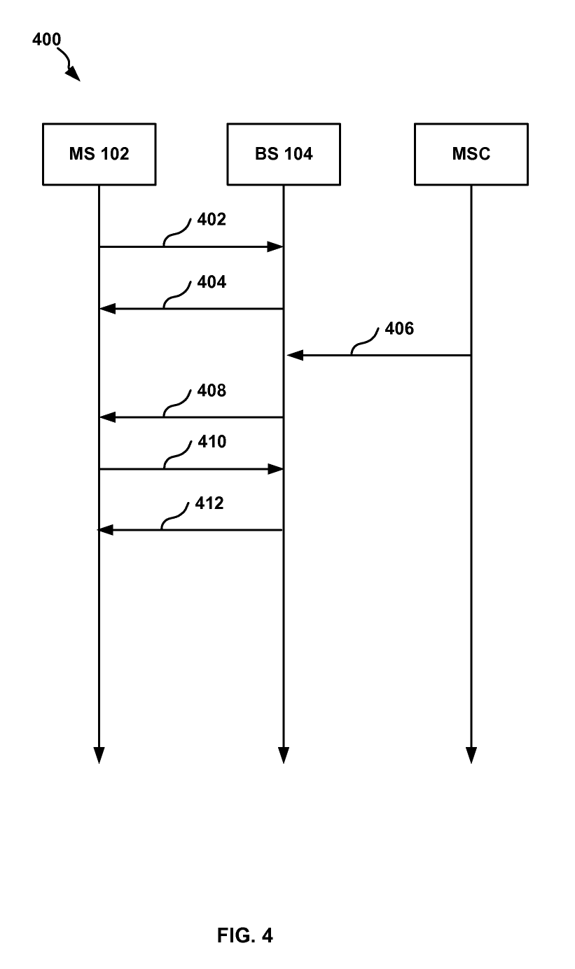

FIG. 4 is a state diagram 400 illustrating an occurrence of a voice call being missed while establishing a data call between devices in the wireless communication system of FIG. 1. As shown, communication between devices is illustrated horizontally with arrows indicating the direction of communication. Further, the communications are shown in time, beginning at the top of FIG. 1 and continuing downward.

In this example, in FIG. 3, the MS 102 may have data to send to another device. Accordingly, the MS 102 may originate a data call (e.g., a 1× data call) by sending a data call origination request (e.g., a service option message) to the BS 104 as shown at 402. In response to the data call origination request, the BS 104 may transmit an acknowledgment (ACK) to the MS 102 indicating receipt of the data call origination request as shown at 404. In the meantime, however, the MSC may receive an indication that there is a voice call pending for the MS 102. Accordingly, the MSC may transmit to the BS 104 a message requesting a page for the voice call be transmitted to the MS 102 as shown at 406. The BS 104 may accordingly transmit a call termination request (e.g., release order) to the MS 102 to terminate the data call origination request in order to allow the MS 102 to receive the voice call as shown at 408. The MS 102, however, after receiving the release order, may still have data buffered for communication in a data call. Accordingly, the MS 102 may try and originate another data call by sending a data call origination request to the BS 104 as shown at 410. The BS 104, meanwhile, may transmit a page for the voice call to the MS 102 as shown at 412. The MS 102, however, after sending the data call origination request may be in a state (e.g., mobile station origination attempt substate) where it is configured to ignore pages. Accordingly, the MS 102 may ignore the page and miss the voice call.

Such a situation as described with respect to FIG. 4 may occur where the BS 104 is configured such that a page is only transmitted to the MS 102 once per time slot (e.g., a 5.12 second time period) and where the MS 102 is configured to originate a data call whenever it has data for a data call. Accordingly, the MS 102 may send multiple data origination requests per time slot, while the BS 104 may only transmit a single page request each time slot. Thus, the time between the BS 104 sending a release order and transmitting a page request may be less than a single time slot, or could be more than a single time slot. In the time between the BS 104 sending a release order and transmitting a page request, the MS 102 may originate another data call and the page request may be ignored. This may cause a delay of several time slots before a voice call is received by the MS 102.

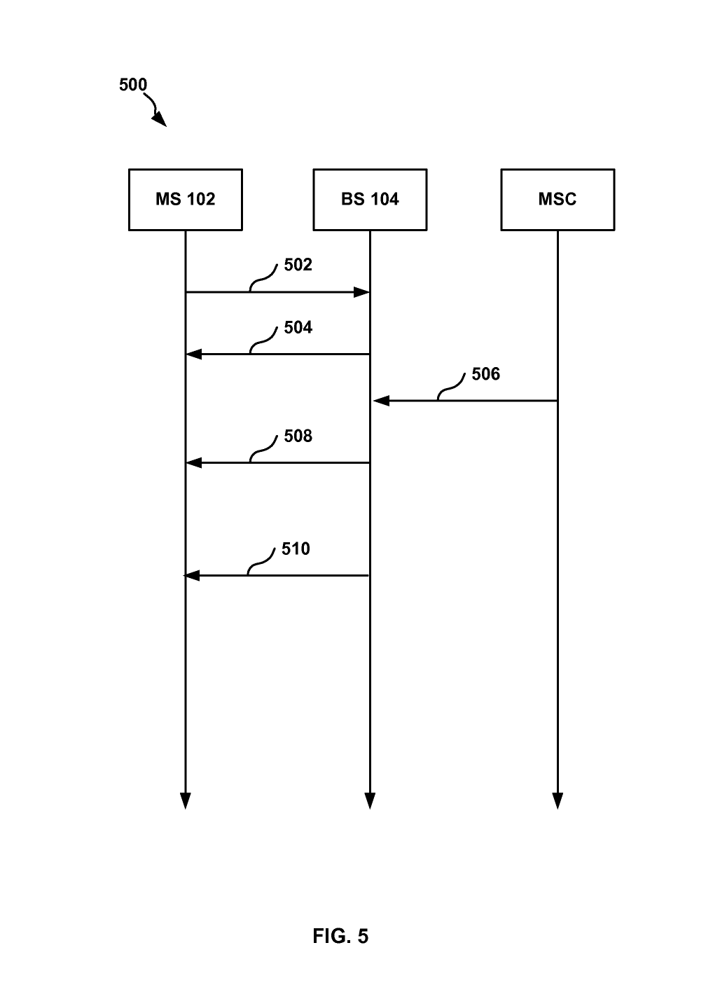

FIG. 5 is a state diagram 500 illustrating a procedure for ensuring receipt of a voice call while establishing a data call between devices in the wireless communication system of FIG. 1. As shown, communication between devices is illustrated horizontally with arrows indicating the direction of communication. Further, the communications are shown in time, beginning at the top of FIG. 1 and continuing downward.

As in FIGS. 3 and 4, the MS 102 may have data to send to another device. Accordingly, the MS 102 may originate a data call (e.g., a 1× data call) by sending a data call origination request (e.g., a service option message) to the BS 104 as shown at 502. In response to the data call origination request, the BS 104 may transmit an acknowledgment (ACK) to the MS 102 indicating receipt of the data call origination request as shown at 504. In the meantime, the MSC may receive an indication that there is a voice call pending for the MS 102. Accordingly, the MSC may transmit to the BS 104 a message requesting a page for the voice call be transmitted to the MS 102 as shown at 506. The BS 104 may accordingly transmit a release order to the MS 102 in order to terminate the data call origination request in order to allow the MS 102 to receive the voice call as shown at 508. The MS 102, after receiving the release order, may be configured to wait for a period of time (e.g., 1 time slot, 2 time slots, or any other number of slots or period of time), which may be configurable, before trying to originate another data call by sending a data call origination request even if the MS 102 has data for transmission in a data call. For example, the period of time the MS 102 waits may be at least 1 time slot or 2 time slots in order to ensure that the BS 104 has sufficient time to transmit a page request between the release order and origination of another data call by the MS 102. Accordingly, the BS 104 may transmit a page request to the MS 102 indicating there is a voice call to the MS 102 as shown at 510. The MS 102, after receiving the release request and before originating another data call may be in a state where it accepts the page request and therefore establishes the voice call.

In further implementations, the BS 104 may be configured to transmit a release order before transmitting a page request to the MS 102 whenever there is a voice call pending for the MS 102, regardless of the state of the MS 102. For example, the MS 102 may be in a state other than a mobile station origination attempt substate, where the MS 102 is also configured to ignore page requests, such as a page response substate or an update overhead information substate entered in response to a page response or origination indication. Accordingly, the MS 102, upon receiving the release order, enters a state where the MS 102 accepts page requests. The MS 102 further waits for a period of time sufficient to allow the BS 104 to transmit a page request to the MS 102 before the MS 102 transitions back to a state where the MS 102 ignores page requests. Accordingly, the MS 102 is ensured to receive the page request regardless of the state of the MS 102 before the release order is received.

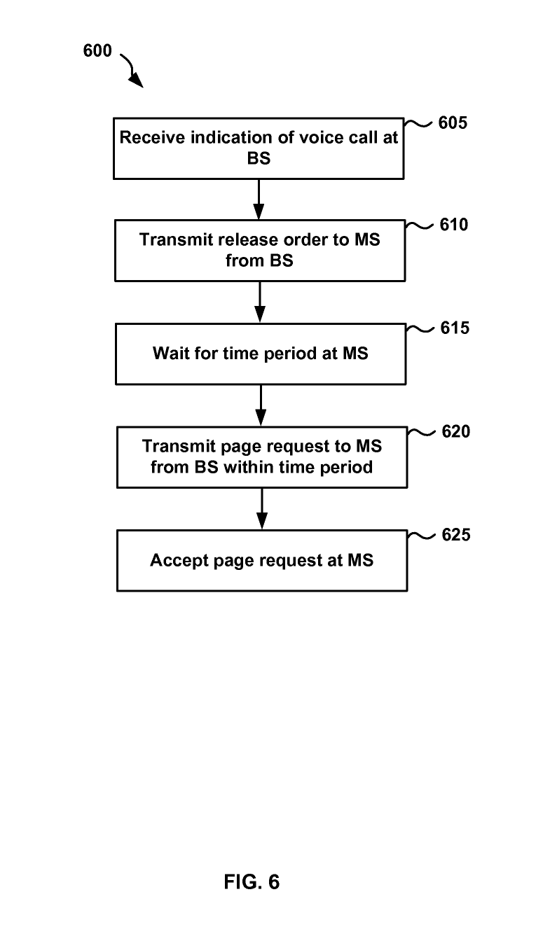

FIG. 6 is a flowchart 600 depicting an exemplary method for ensuring receipt of a voice call while establishing a data call between devices in the wireless communication system of FIG. 1. Although the method of flowchart 600 is described herein with reference to the BS 104, MS 102, and MSC discussed above, a person having ordinary skill in the art will appreciate that the method of flowchart 600 may be implemented by another suitable devices. Although the method of flowchart 600 is described herein with reference to a particular order, in various embodiments, blocks herein may be omitted and additional blocks may be added.

At a block 605, the BS 104 may receive, such as from the MSC, an indication that there is a voice call pending for the MS 102. Further, at a block 610, the BS 104 may transmit a release order to the MS 102. Continuing, at a block 615, the MS 102 may transition to a state where the MS 102 accepts page requests and wait for a period of time based on the receipt of the release order before transitioning to a state where the MS 102 does not accept page requests. In one example, the period of time may be based on an estimated period of time (e.g., 1, 2, or more time slots) that the BS 104 will take to transmit a page request after the release order. At block 620, the BS 104 may transmit a page request to the MS 102. At block 625, the MS 102, which is in a state where the MS 102 accepts page requests, accepts the page request and may continue with establishment of the voice call.

The various illustrative logics, logical blocks, modules, circuits and algorithm steps described in connection with the implementations disclosed herein may be implemented as electronic hardware, computer software, or combinations of both. The interchangeability of hardware and software has been described generally, in terms of functionality, and illustrated in the various illustrative components, blocks, modules, circuits and steps described above. Whether such functionality is implemented in hardware or software depends upon the particular application and design constraints imposed on the overall system.

The hardware and data processing apparatus used to implement the various illustrative logics, logical blocks, modules and circuits described in connection with the aspects disclosed herein may be implemented or performed with a general purpose single- or multi-chip processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, or, any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. In some implementations, particular steps and methods may be performed by circuitry that is specific to a given function.

In one or more aspects, the functions described may be implemented in hardware, digital electronic circuitry, computer software, firmware, including the structures disclosed in this specification and their structural equivalents thereof, or in any combination thereof. Implementations of the subject matter described in this specification also can be implemented as one or more computer programs, i.e., one or more modules of computer program instructions, encoded on a computer storage media for execution by, or to control the operation of, data processing apparatus.

Various modifications to the implementations described in this disclosure may be readily apparent to those skilled in the art, and the generic principles defined herein may be applied to other implementations without departing from the spirit or scope of this disclosure. Thus, the claims are not intended to be limited to the implementations shown herein, but are to be accorded the widest scope consistent with this disclosure, the principles and the novel features disclosed herein. The word “exemplary” is used exclusively herein to mean “serving as an example, instance, or illustration.” Any implementation described herein as “exemplary” is not necessarily to be construed as preferred or advantageous over other implementations.

Certain features that are described in this specification in the context of separate implementations also can be implemented in combination in a single implementation. Conversely, various features that are described in the context of a single implementation also can be implemented in multiple implementations separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Further, the drawings may schematically depict one more example processes in the form of a flow diagram. However, other operations that are not depicted can be incorporated in the example processes that are schematically illustrated. For example, one or more additional operations can be performed before, after, simultaneously, or between any of the illustrated operations. In certain circumstances, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products. Additionally, other implementations are within the scope of the following claims. In some cases, the actions recited in the claims can be performed in a different order and still achieve desirable results.

What is claimed is:

1. A method of communicating in a wireless network, the method comprising:
receiving, at a first unit, a data call termination request from a second unit; and
waiting, by the first unit, for a time period before attempting to place a data call based on receipt of the data call termination request.

2. The method of claim 1, further comprising receiving, at the first unit, a page request for a voice call from the second unit during the time period, and accepting the voice call.

3. The method of claim 1, wherein the wireless network comprises a code division multiple access network and wherein the data call termination request comprises a release order.

4. The method of claim 1, wherein the time period is one or two time slots.

5. The method of claim 1, further comprising transitioning from a first state where a page request is not accepted to a second state where the page request is accepted based on receiving the data call termination request.

6. The method of claim 1, wherein the first state comprises at least one of the following: mobile station origination attempt substate, page response substate, and update overhead information substate.

7. A method of communicating in a wireless network, the method comprising:
receiving, at a first unit, an indication of a pending voice call from a second unit; and
transmitting, by the first unit, a data call termination request to a third unit based on the received indication.

8. The method of claim 7, wherein the data call termination request is configured to cause a recipient of the data call termination request to wait for a period of time before attempting to place a data call based on receipt of the data call termination request.

9. The method of claim 8, further comprising transmitting a page request for the pending voice call during the time period to the recipient.

10. A wireless device configured to communicate in a wireless network, the wireless device comprising:
a receiver configured to receive a data call termination request; and
a processor configured to wait for a time period before attempting to place a data call based on receipt of the data call termination request.

11. The wireless device of claim 10, wherein the receiver is further configured to receive a page request for a voice call during the time period, and the processor is further configured to accept the voice call.

12. The wireless device of claim 10, wherein the wireless network comprises a code division multiple access network and wherein the data call termination request comprises a release order.

13. The wireless device of claim 10, wherein the processor is further configured to transition from a first state where a page request is not accepted to a second state where the page request is accepted based on receiving the data call termination request.

14. A wireless device configured to communicate in a wireless network, the wireless device comprising:
a receiver configured to receive an indication of a pending voice call; and
a transmitter configured to transmit a data call termination request based on the received indication.

15. The wireless device of claim 14, wherein the data call termination request is configured to cause a recipient of the data call termination request to wait for a period of time before attempting to place a data call based on receipt of the data call termination request.

16. The wireless device of claim 14, wherein the transmitter is further configured to transmit a page request for the pending voice call during the time period to the recipient.

17. An apparatus for communicating in a wireless network, the apparatus comprising:
means for receiving a data call termination request; and
means for waiting for a time period before attempting to place a data call based on receipt of the call termination request.

18. An apparatus for communicating in a wireless network, the apparatus comprising:
means for receiving an indication of a pending voice call; and
means for transmitting a data call termination request based on the received indication.

19. A non-transitory computer-readable medium comprising code that, when executed by one or more processors, causes an apparatus to:
receive a data call termination request; and
wait for a time period before attempting to place a data call based on receipt of the call termination request.

20. A non-transitory computer-readable medium comprising code that, when executed by one or more processors, causes an apparatus to:
receive an indication of a pending voice call; and
transmit a data call termination request based on the received indication.
